(19) United States
(12) Patent Application Publication
(10) Pub. No.: US 2016/0156254 A1
(43) Pub. Date: Jun. 2, 2016

(54) PROGRESSIVE MAGNETIC ROTATION MOTOR

(71) Applicant: Dale Bowen, Southington, OH (US)

(72) Inventor: Dale Bowen, Southington, OH (US)

(21) Appl. No.: 14/556,558

(22) Filed: Dec. 1, 2014

(51) Int. Cl. H02K 16/00; H02K 1/22; H02K 11/00

(52) U.S. Cl. CPC H02K 16/005; H02K 11/0021; H02K 1/223

(57) ABSTRACT

New permanent magnetic motor utilizing interacting rows of magnets on rotor poles and a main rotor. The rotor poles have rows of permanent magnets with increasing numbers of magnets per row. The main rotor has magnets and an electro-magnet. Magnets are arranged in opposite direction and polarity on the rotor poles in relation to the main rotor. Magnetic attraction of rotor poles to the main rotor magnets results in a progressive magnetic rotational action producing rotational output. The motor is started, operated and stopped utilizing an electronic controller. Constant rotation is maintained by pulsing the electro-magnet with the controller synchronized to a feedback sensor located on the main rotor shaft.

### BACKGROUND OF THE INVENTION

1. Technical Field

This invention relates to magnetic motors in general, and more particularly to a motor having multiple rotors with permanent magnets which interact with one another to produce a mechanical output.

2. Description of Prior Art

Magnetics are well-known in the art and have been developed and used for many years. Examples of such can be seen in U.S. Pat. Nos. 3,686,524, 3,935,487, 4,358,693, 5,448,116, 7,898,135, and U.S. Publications 2003/0062785, 2008/0122299, and U.S. Publication 2010/0219703.

In U.S. Pat. No. 3,686,524, a permanent magnet motor is disclosed having permanent magnets housed in a casing of magnetically safe material; an armature about the permanent magnets with a dimensional ratio therebetween.

U.S. Pat. No. 3,935,487 illustrates a permanent magnetic motor that utilizes a moveable magnetic shield interposed between magnets when they are adjacent one another, and moving to then expose shield magnet as a moveable magnetic shield passes by.

U.S. Pat. No. 4,358,693 claims a permanent magnetic motor having multiple stators and rotators with each stator having an electro-magnetic coil and each contacting rotor permanent magnets with their magnetic poles in alternate polarity.

U.S. Pat. No. 5,448,116 discloses a linear magnetic motor with rotational output having multiple stationary electro-magnets coupled to a power source.

U.S. Pat. No. 7,898,135 shows a hybrid permanent magnetic motor with permanent magnets placed in a magnetically attracting manner and inter-dispersed between control coils. The control coils are energized to create a flux opposing the flux of the permanent magnets and to create rotational torque on the poles of the salient pole rotor before those poles align with the poles of the energized control coil stator segment.

U.S. Publication 2003/0062785 defines a MagnoDrive “magnetic motor” that has a stator cylindrical magnet and a rotor assembly that does not require any external power input. The design requires large magnets with all South Poles on the inside of a stator and South Poles on the rotor, defining an alleged workable motor output.

U.S. Publication 2010/0219703 illustrates a magnetic motor having a piston and cylinder configuration with multiple electro-magnetic coils around the cylinder for selective activation, pulling the piston up and down within the cylinder.

### SUMMARY OF THE INVENTION

A magnetic motor that utilizes multiple permanent magnets positioned on at least two rotors in an adjacent magnetic communication with one another. Multiple rows of permanent magnets on each rotor in magnetic polar opposition sequence engage imparting rotational input force therebetween. A single electro-magnet on a main rotor is pulsed by a controller so as to maintain progressive magnetic rotation output synchronized by a feedback sensor. Magnet rows on each rotor are of an ascending number, is defining the rotational magnetic sequence of opposing pole engagement through the rotor output imparted thereby.

### DESCRIPTION OF THE DRAWINGS

FIG. 1 is a cross-sectional view of the magnetic motor of the invention.

FIG. 2 is a side elevational view of the main rotor thereof.

FIG. 3 is a side elevational view of a rotor pole.

FIG. 4 is an enlarged front elevational view of an eighth rotor pole sub-assembly magnet mounting disk.

FIG. 5 is a side elevational view thereof.

FIG. 6 is an enlarged front elevational view of a seventh rotor pole sub-assembly magnet mounting disk.

FIG. 7 is an enlarged side elevational view thereof.

FIG. 8 is an enlarged front elevational view of a first main rotor pole sub-assembly magnet mounting disk.

FIG. 9 is a side elevational view thereof.

FIG. 10 is a front elevational view of a magnetic timing wheel.

FIG. 11 is a side elevational view thereof.

FIG. 12 is a side elevational view of the multiple rotor progressive magnetic rotation motor of the invention.

FIG. 13 is end view thereof with portions graphically illustrated in broken lines within.

FIG. 14 is an operational positional representation of the rotor pole magnets and numerical indication for each.

FIG. 15 is an operational positional representation thereof.

FIG. 16 is an operational positional representation thereof.

FIG. 17 is a linear graphic representation of the number and position and orientation for a rotor pole.

FIG. 18 is a linear graphic representation of the number and position and orientation for the main rotor.

### DESCRIPTION OF THE PREFERRED EMBODIMENT

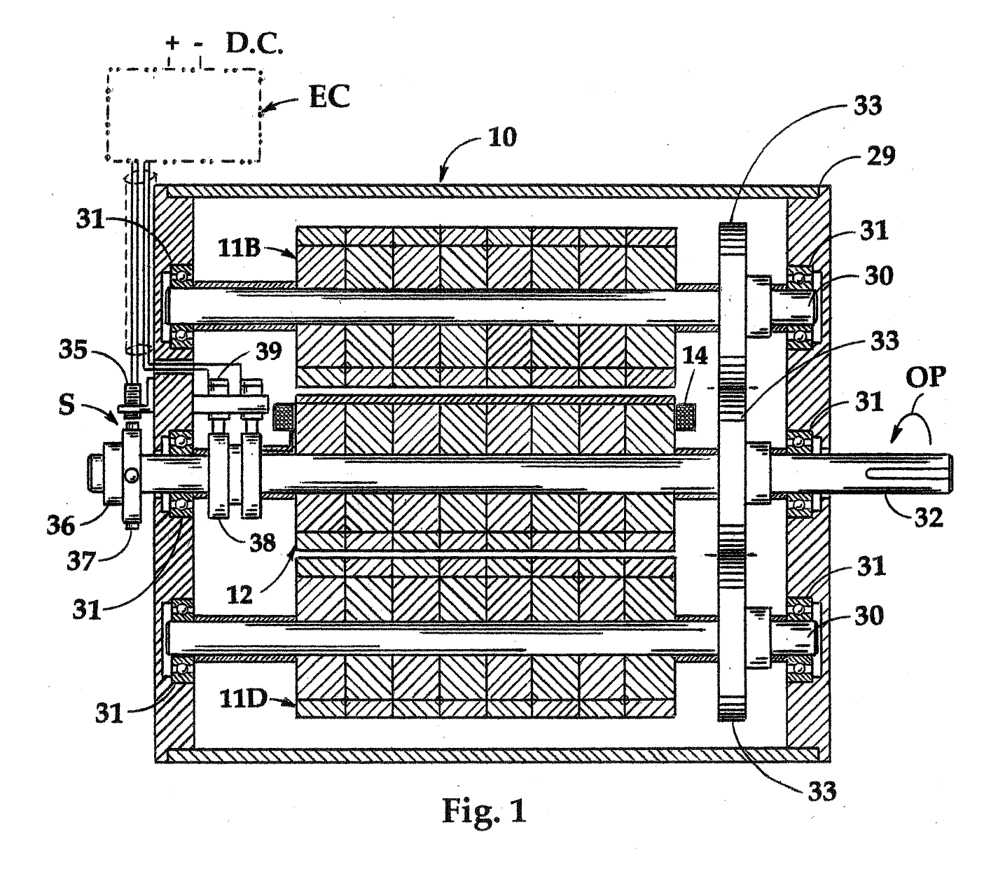

Referring to FIG. 1 and FIG. 14 of the drawings, a progressive magnetic rotational motor 10 of the invention is of a direct current DC permanent magnetic motor having multiple permanent magnet pole rotors 11A, 11B, 11C, 11D and a main rotor 12 consisting of permanent magnets and a single electro-magnet. The rotor poles 11 are arranged for magnetic interaction with the main rotor 12. All of the rotors have a plurality of magnetic pole oriented permanent magnets 13, which are positioned annularly and longitudinally thereon in a specific numerical order and magnetic pole orientation as will be described in detail hereinafter.

The main rotor 12 has an electro-magnetic coil 14 that is pulsed on and off by an electronic controller EC to provide electro-magnetic input at a critical point in their representative rotational positioning during operation to start, maintain, or stop rotation. The magnetic induced rotation mechanical force is indicated by directional arrows D on a drive output shaft 32 of the main rotor 12 and rotor poles 11A, 11B, 11C and 11D.

The main rotor 12 has interlinking positional gearing 33 with the foregoing magnetically driven rotor poles 11A, 11B, 11C and 11D, as will be described in greater detail hereinafter.

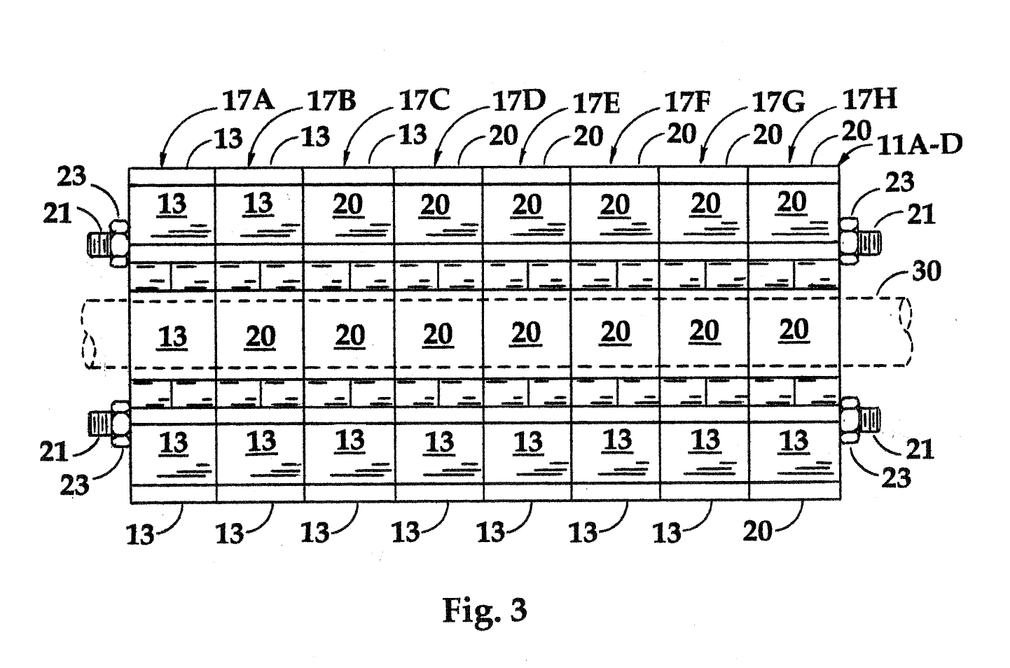

Each of the respective rotor poles 11, best seen in FIGS. 1 and 3 of the drawings, is in this example constructed of a plurality of sub-assembly disks 17A, 17B, 17C, 17D, 17E, 17F, 17G, 17H which are made in this example from formed powder metal according to well-known and accepted manufacturing processes. Powder metal fabrication processes are used due to its magnetic properties and ease of formation.

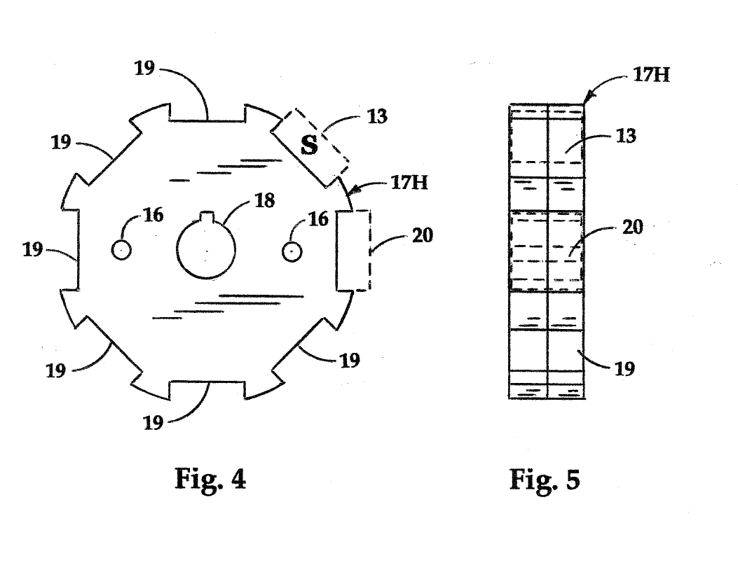

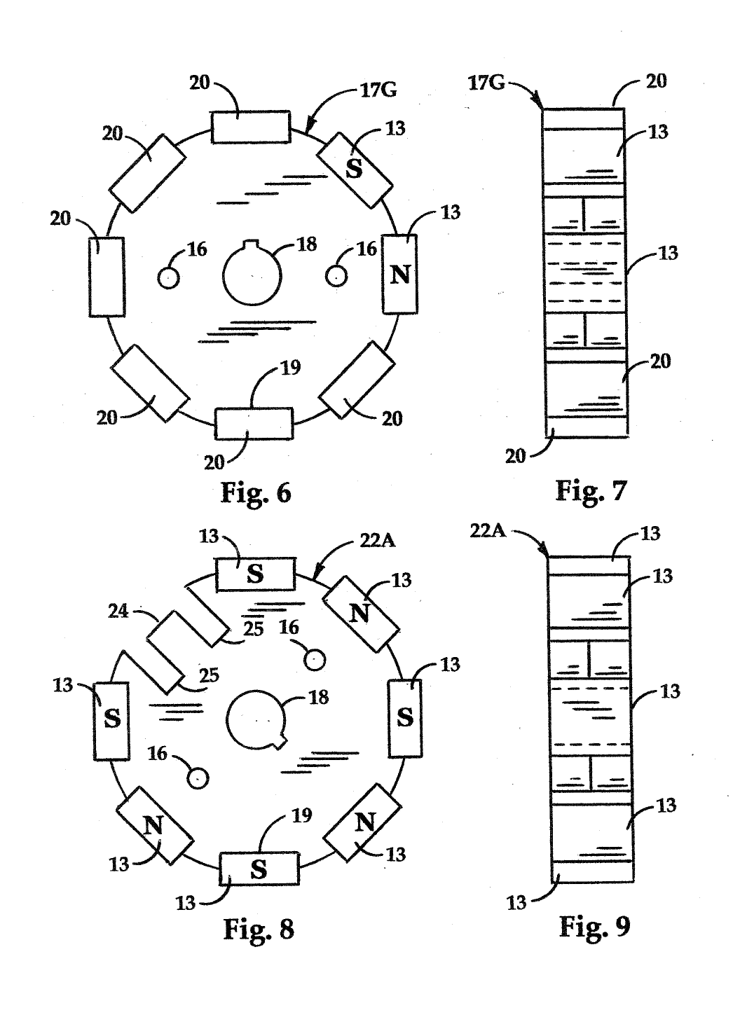

Each disk 17 is identical, having a keyed center aperture 18 and a plurality of magnet and weight mounting notches 19 in annular space-relation to one another about its perimeter edge surface 17H, best seen in FIGS. 4 and 5 of the drawings. A pair of parallel spaced assembly apertures 16 is formed within the field of the disk 17 in aligned space-relation with the central keyed opening 18. Each of the multiple disks 17A, 17B, 17C, 17D, 17E, 17F, 17G, 17H which are required to form a rotor pole 11 have one or more permanent magnets 13 secured within the respective mounting notches 19 in rotational numerical sequence as illustrated in broken lines in FIGS. 4 and 5 of the drawings, with one magnet 13 and in FIGS. 6 and 7 with two magnets 13. The remainder of open notches 19 in each disk, have a balance weight 20 of an equal dimension and mass to that of the magnet 13, secured within to provide rotational balance to the disk 17. Each of the magnets 13 is arranged in reverse magnetic pole (North) (South) orientation to its adjacent magnet as seen in FIGS. 6 and 7 of the drawings, and graphically in operational FIGS. 14, 15, and 16 of the drawings.

The multiple disks 17A, 17B, 17C, 17D, 17E, 17F, 17G, 17H, each with a different ascending number of permanent magnets 13 beginning with one magnet 13 on disk 17H and ending with eight magnets 13 on disk 17A thereabout.

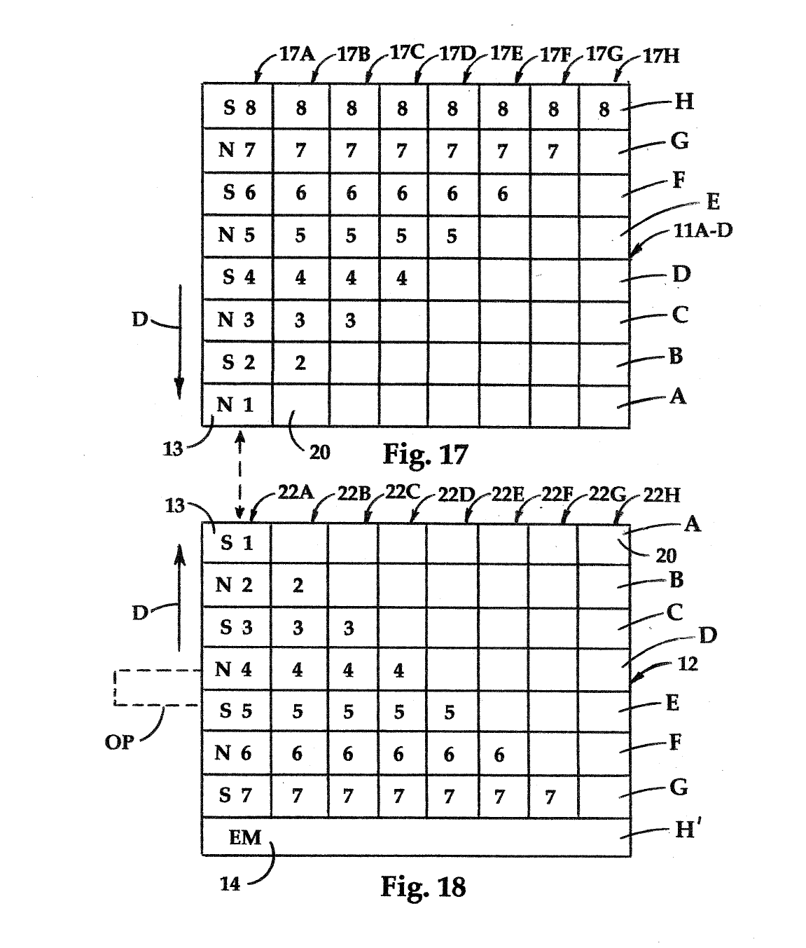

The disks 17A, 17B, 17C, 17D, 17E, 17F, 17G, 17H are assembled together by a pair of threaded retainment fastener rods 21 through the assembly aperture 16 and corresponding engagement nuts 23 forming a single rotor pole 11 as seen in FIG. 3 of the drawings. Given their keyed aligned orientation and the sequential positioning of the magnets 13 and corresponding balance weights 20, each of the rotor poles 11 will have in effect longitudinal rows of permanent magnets 13 of varying lengths in progressive numerically ascending manner, as illustrated graphically in FIG. 17 of the drawings. Each of the longitudinal extending rows of magnets will be of the same magnetic pole (North) or (South) respectively.

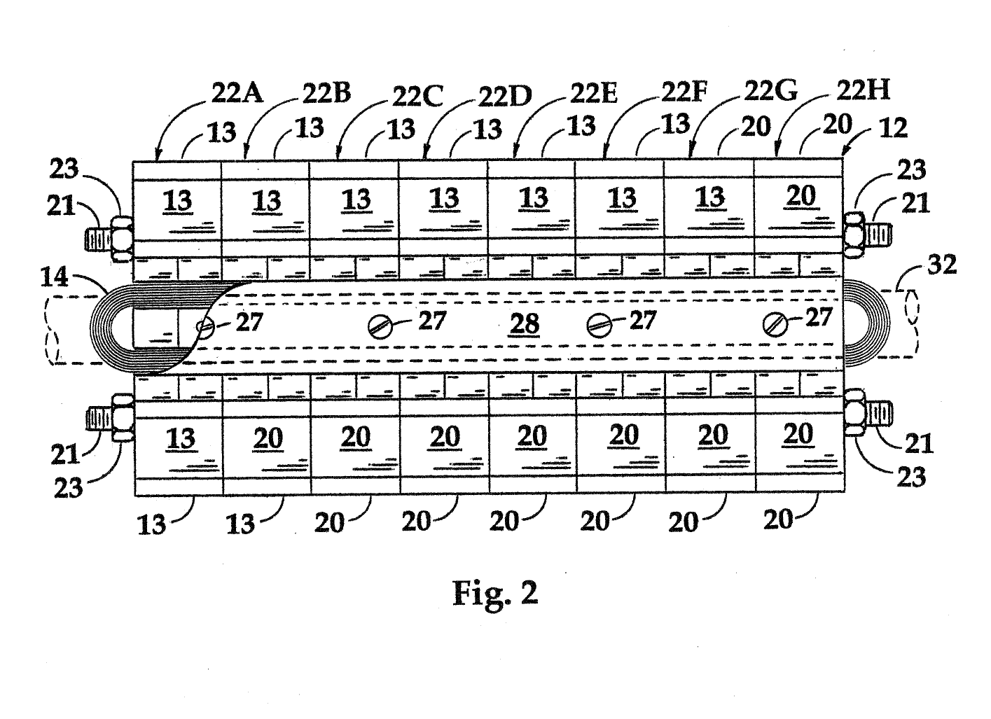

Referring now to FIG. 1 and FIG. 2 of the drawings, the main rotor 12 can be seen, which is comprised of multiple main rotor disks 22A, 22B, 22C, 22D, 22E, 22F, 22G, 22H as seen in FIG. 8 and FIG. 9 of the drawings. Each of the disks 22 are identical to the sub-assembly rotor pole disk 17 as hereinbefore described, with a plurality of annularly spaced notches 19 with the addition of electro-magnetic mounting fitting 24 in place of one of the mounting notches 19. The electro-magnetic mounting fitting 24 has a pair of coil receiving notches 25 around which an electro-magnetic coil 14 winding is positioned when assembled on the main rotor 12. The remaining magnetic and weight mounting notches 19 have a sequential arrangement of permanent magnets 13 and balance weights 20 with the same numerical ascending magnets 13 and corresponding number of descending weights per disk, as seen in FIG. 2 of the drawings. It will be evident that the assembled disks 22A, 22B, 22C, 22D, 22E, 22F, 22G, 22H also have a keyed center aperture 18 and assembly receiving apertures 16 for corresponding engagement of threaded rods 21 and fastener nuts 23 to secure the plurality of disks 22 together, forming the main rotor 12.

Once assembled, a coil cover plate 28 is secured over the exposed portion of the electro-magnetic coil 14 with screws 27, as illustrated in FIG. 2 of the drawings.

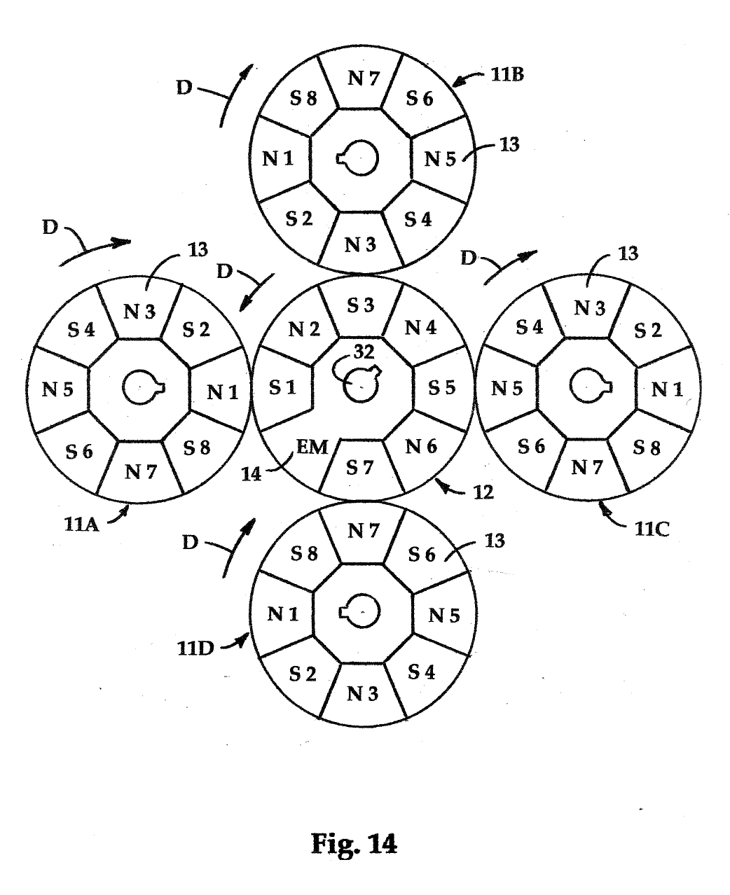

In this example chosen for illustration, the progressive magnetic rotational motor 10 utilizes multiple rotor poles 11A, 11B, 11C, 11D arranged for magnetic drive engagement about the central main rotor 12, as seen in FIGS. 1, 13 and FIG. 14 of the drawings in a support housing 29 with corresponding keyed support shafts 30 with individual shaft bearing assemblies 31 to support same.

The main rotor 12 is correspondingly assembled as noted on a keyed drive output shaft 32 with respective bearing assemblies 31 within the support housing 29.

The rotational position timing gears 33 are positioned on the respective keyed shafts 30 and drive shaft 32 inter-engaged to one another to prevent the respective rotors from slipping out of synchronization.

Referring now to FIGS. 14, 15, and 16 of the drawings, the rotor pole permanent magnets 13 positioning is illustrated with aligned magnet numbers in longitudinal rows, such as rotor pole 11A having one magnet (North Pole) and main rotor 12 having one magnet (South Pole) and so on. Each of the rotor poles 11A, 11B, 11C, 11D have the same overall number of magnets 13 arranged in respective longitudinal row of corresponding numbers from one magnet to eight magnets, illustrated graphically in FIG. 17 of the drawings, for longitudinally defined rows A, B, C, D, E, F, G, H respectively. The main rotor 12 only has seven longitudinal magnet rows A, B, C, D, E, F, G, with the electro-magnet EM defining a longitudinal row H′, as seen graphically in FIG. 18 of the drawings.

It will thus be seen that the arrangements of the magnets 13 in opposite magnetic pole direction on the respective sub-assemblies disks 17 and 22 annular rows that they will therefore effectively rotate due to the magnetic pole orientation once started by the electro-magnet EM in a sequential function; therefore achieving the hereinbefore described progressive magnetic rotation and provide mechanical rotational output to the drive rotor shaft 32.

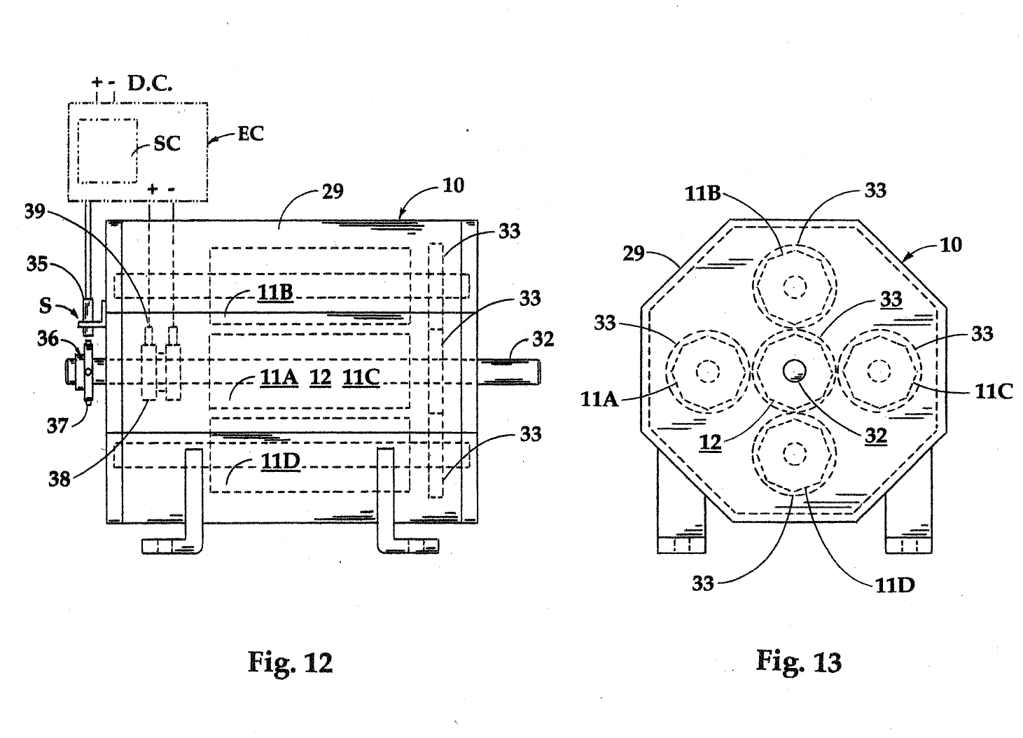

The electro-magnet EM as noted is sequentially timed for activation required for operation is determined by an electronic controller EC indicated in broken lines in FIG. 1 and FIG. 12 of the drawings. A feedback sensor S is required and mounted on the back of the magnetic motor 10 comprising a hall effect pickup 35 and magnetic timing wheel 36 used in this example. It will be evident that other known feedback devices can be used, such as encoders, as is well-known and understood within the art.

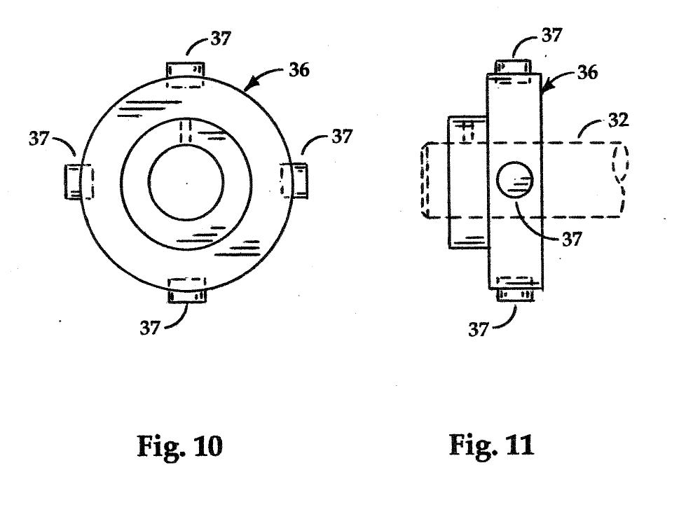

The magnetic timing wheel 36 in this example, as seen in FIG. 10 and FIG. 11 of the drawings, has multiple timing magnets 37 positioned in space annular relation thereon, with the hall effect pickup 35 seen in FIGS. 1 and 12 of the drawings, positioned to synchronize the rotation of the magnetic timing wheel 36 with the main rotor drive shaft 32. Given the orientation of the timing magnet 37 this happens four times per revolution and is in communication with the electronic controller EC for effective pulse activation of the electro-magnet EM. An electric power transfer slip ring 38 with contact brushes 39 provide an electrical connection between the electronic controller EC and the rotating electro-magnet EM, as is typical within the art.

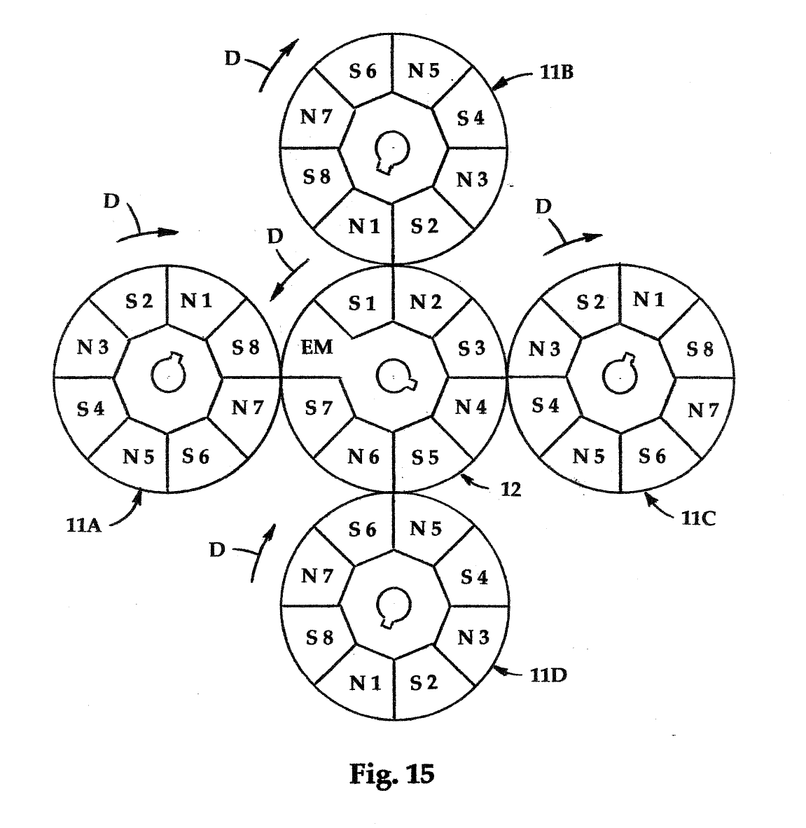

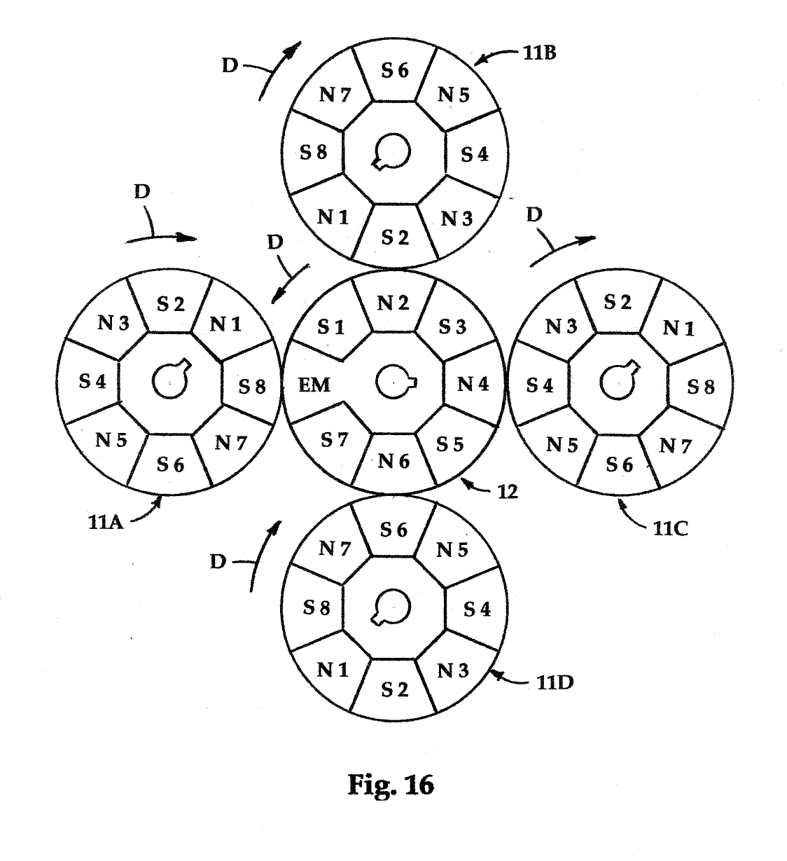

The operational function of the magnetic motor 10 by the permanent magnet orientation and engagement is graphically illustrated for better understanding in FIG. 14, FIG. 15, and FIG. 16, wherein the magnet 13 designated N1 (North Pole) on the rotor pole 11A and the magnet 13 designated S1 (South Pole) on the main rotor 12 are attracted to one another defined as one magnetic set each. The magnet row, having two magnets 13, defined as S2 (South) and N2 (North) on the respective rotors, rotationally overtake the “one set” magnets in a progressive matter thus inducing rotation thereto. This sequential overtaking of the next magnet set, which is of increasing magnet numbers, provides rotation between the respective multiple rotor poles 11A, 11B, 11C, 11D and the main rotor 12 rotating therefore the drive shaft 32 providing useable mechanical output OP, as seen in FIGS. 1 and 18 of the drawings.

Referring now to FIG. 15 of the drawings, the progressive rotation of the rotor pole 11 and main rotor 12 is illustrated wherein the rotor pole 11A eight magnets 13 designated as numeral S8 (South Pole) are approaching the electro-magnet EM of the main rotor 12. The hall effect pickup 35 generates a signal induced from the magnets 37 on the magnetic timing wheel 36 to the electronic controller EC. This in turn activates a source of DC power, pulsing same to the electro-magnet EM through the hereinbefore described power transfer slip ring brush assembly 38 with contact brushes 39 and energizes the electro-magnet EM into a magnetic North Pole, equal in strength to that of the eight approaching rotor pole 11A South Pole S8 magnets designated illustration in FIG. 17 as row H of the longitudinal aligned magnets with the magnetic poles therefore attracting to one another.

Referring now to FIG. 16 of the drawings, the rotor pole rotational progress sequence shows that the rotor pole 11A South Pole S8 is now facing the energized electro-magnet EM. At this point in the operational sequence, the electronic controller EC de-energizing the electro-magnet EM, thus collapsing the field. This changes its polarity from North to South, which therefore repels the rotors back to the first defined magnet set of one. It will be evident that this action restarts the rotational cycle and the magnetic motor 10 continues to run. It will be seen that the number of energized electro-magnet pulses are determined by the number of rotor poles used, which in this example is four; thus four pulses per revolution are required.

The magnetic motor 10 will run at constant speed, which depends on the design of the motor and can be varied slightly by the effective feedback timing as described.

To stop the magnetic motor 10, the electro-magnet EM is de-energized, at which point the motor 10 will stop with the respective rows of seven magnets facing one another on any one of the rotor poles 11 and main rotor 12.

Correspondingly, to start the motor 10, the electro-magnet EM is initially energized using a separate starter circuit SC indicated generally by broken lines and the electronic controller EC with the number of strong starter pulses corresponding to the rotor pole for one revolution, after which the hereinbefore described pulsing is engaged to maintain the rotation.

It will thus be seen that a new and novel permanent magnet motor has been illustrated and described utilizing a novel, progressive magnetic rotation action, and that various changes and modifications may be made thereto without departing from the spirit of the invention, therefore I claim:

1. A permanent magnet motor comprising,
a support housing,
a main rotor with an output shaft and at least one rotor pole in a rotational position within said housing,
multiple permanent magnets on said main rotor and said rotor pole in magnetic rotational engagement with one another,
said permanent magnets arranged in annular space-relation to one another in numerically increasing longitudinal rows,
an electro-magnet on said main rotor for sequential electro-magnet engagement with said permanent magnet rows on said rotor pole,
said permanent magnet rows in alternate magnetic pole orientation to one another to induce movement between said respective main rotor and said respective rotor pole during rotation thereof,
an electrical controller in communication with a source of power and said electro-magnet for pulsing electro-magnet during use.

2. The permanent magnetic motor set forth in claim 1 wherein in said main rotor and said rotor pole have multiple balance weights in annular space-relation thereon.

3. The permanent magnetic motor set forth in claim 1 wherein said electronic controller comprises,
an electronic control circuit and a starter circuit,
and a feedback sensor assembly in communication with the main rotor.

4. The permanent magnetic motor set forth in claim 3 wherein said feedback sensor comprises,
a hall effect pickup and a magnetic timing wheel on said main rotor output shaft,
multiple magnets on said magnetic timing wheel for sequential communication with said hall effect pickup generating selective electrical signals to said controller.

5. A permanent magnet motor set forth in claim 3 wherein said electronic controller circuit generates an electrical energy pulse to said electro-magnet in relation to the rotation of said main rotor.

6. The permanent magnet motor set forth in claim 3 wherein said starter circuit comprises,
power output to said electro-magnet independently of said magnetic timing wheel of said feedback sensor assembly.

7. A magnetic motor comprising,
a support housing,
a main rotor rotatable within said housing and an output shaft in said main rotor,
a plurality of rotor poles rotatably positioned within said housing arranged about said main rotor,
multiple permanent magnets on said main rotor and said respective rotor poles,
said permanent magnets arranged in numerically increasing longitudinal rows in annular spaced-relation to one another,
an electro-magnet on said main rotor for sequential magnetic engagement with permanent magnet row on each of said respective multiple rotor poles,
a controller in electrical communication with said electro-magnet.

8. The magnetic motor set forth in claim 7 wherein said permanent magnet rows on said main rotor and said multiple rotor poles attract each other to movement towards one another in a successive counter-rotational path of increasing magnets per longitudinal row.

9. The magnetic motor set forth in claim 7 wherein said electronic controller selectively energizes said electro-magnet coil whereby rotation of the maximum magnet longitudinal row on said respective rotor poles is activated maintaining the rotational path to the adjacent minimum numerical magnet longitudinal rows.
